(19) United States
(12) Patent Application Publication
(10) Pub. No.: US 2004/0172960 A1
(43) Pub. Date: Sep. 9, 2004

(54) Air conditioner for vehicle

(76) Inventors: Hiroki Nakamura, Chiryu-city (JP); Tetsuya Takechi, Handa-city (JP)

Correspondence Address: HARNESS, DICKEY & PIERCE, P.L.C., P.O. BOX 828, BLOOMFIELD HILLS, MI, 48303, US

(21) Appl. No.: 10/784,038

(22) Filed: Feb. 20, 2004

(30) Foreign Application Priority Data
Feb. 21, 2003 (JP) 2003-044177

(51) Int. Cl. F25B 1/00; B60H 1/32; F25B 49/00

(52) U.S. Cl. 62/228.1; 62/244; 62/230

(57) ABSTRACT

In a normal control of a vehicle air conditioner, a control unit controls a compressor so that a work amount of the compressor is maintained at a target work amount calculated based on a heat load. In a cut control, the control unit controls the compressor so that the work amount is forcibly reduced smaller than the target work amount. When the cut control is set from the normal control, the cut control is continued for a predetermined time and then is changed to the normal control again. In this case, the work amount of the compressor immediately after the predetermined time passes is corrected to be increased. Thus, the target work amount of the compressor immediately after the cut control is increased larger than the target work amount calculated based on the heat load. Therefore, suitable air conditioning can be performed immediately after the cut control.

### CROSS REFERENCE TO RELATED APPLICATION

This application is based on Japanese Patent Application No. 2003-44177 filed on Feb. 21, 2003, the disclosure of which is incorporated herein by reference.

### BACKGROUND OF THE INVENTION

1. Field of the Invention

The present invention relates to an air conditioner for a vehicle. More particularly, the present invention relates to a control system for controlling a work amount (operation amount) of a compressor in the air conditioner.

2. Description of Related Art

In a conventional vehicle, a cut control of a compressor is performed when the vehicle is accelerated in order to pass other vehicle which runs forward. The cut control of the compressor is a control for ensuring an acceleration of a vehicle engine by reducing a load of the compressor which is driven by the vehicle engine. For example, the cut control of the compressor in a vehicle acceleration is disclosed in U.S. Pat. No. 5,257,507 (corresponding to JP-A-H5-58151). Specifically, the cut control is performed when a running load of the vehicle engine exceeds a predetermined load (heavy load), for example, by pedaling an acceleration pedal. In addition to the vehicle acceleration, a case where a vehicle is going up in a slope is also an example of the heavy load.

In a fixed displacement compressor, the compressor is stopped by cutting off an electromagnetic clutch, so as to reduce the load of the compressor. In a variable displacement compressor, a discharge amount of the compressor is reduced for reducing the load of the compressor. In an electric compressor, a rotation speed of the compressor is reduced so as to ensure auxiliary driving power.

When the cut control is not performed, operation of the compressor is controlled so that a work amount of the compressor is maintained at a target work amount calculated based on a heat load. Specifically, in the fixed displacement compressor, a connection time of the electromagnetic clutch per a regular time corresponds to the above work amount. In the variable displacement compressor, the discharge amount of the compressor per rotation corresponds to the above work amount. In the electric compressor, the rotation speed of the compressor corresponds to the above work amount.

When the cut control is performed, a temperature of an evaporator increases. Therefore, the temperature of the evaporator needs to be decreased immediately after the cut control is terminated. According to the above conventional compressor control, the target work amount after the cut control is increased based on the heat load, compared with the target work amount at a time immediately before the cut control is started, because the heat load increases immediately after the cut control is terminated. However, it is not enough to reduce the temperature of the evaporator immediately.

Further, the above compressor control is regarding a cooling operation. In a heating operation where heat is radiated in an interior heat exchanger by operating the compressor used for a heat pump cycle, a temperature of the interior heat exchanger needs to be increased immediately after the cut control is terminated. In this case, the operation of the compressor is controlled so that the work amount of the compressor approximates to the target work amount calculated based on the heat load. However, it is not enough to increase the temperature of the interior heat exchanger immediately.

### SUMMARY OF THE INVENTION

In view of the foregoing problems, it is an object of the present invention to provide a vehicle air conditioner which performs an air-conditioning control so that air condition in a passenger compartment suits a passenger's feeling immediately after a cut control of a compressor is terminated.

According to the present invention, a vehicle air conditioner includes a compressor for compressing and discharging refrigerant in a refrigerant cycle, an interior heat exchanger that performs a heat exchange between the refrigerant circulated by operation of the compressor and air to be blown into a vehicle compartment, and a control unit for controlling a work amount of the compressor. The control unit has a target work amount calculating means for calculating a target work amount of the compressor per a regular time based on a heat load of the interior heat exchanger. Further, the compressor is controlled by the control unit to perform a normal control where the compressor is operated based on the target work amount, and a cut control where the work amount of the compressor is forcibly reduced smaller than the target work amount. In the vehicle air conditioner, the control unit corrects the target work amount calculated by the target work amount calculating means based on the heat load to be increased immediately after the cut control, when the normal control is performed after the cut control is performed for a predetermined time. Thus, the air condition in the passenger compartment can be made to suit a passenger's feeling immediately after the cut control is terminated. For example, when a running load of the vehicle exceeds a predetermined load, the cut control is performed so that the control unit controls the work amount of the compressor to be forcibly reduced in the cut control.

Preferably, the control unit corrects the target work amount of the compressor immediately after the cut control to be increased as the predetermined time is longer. Alternatively, the control unit corrects the target work amount of the compressor immediately after the cut control to be increased as the work amount of the compressor immediately before the cut control is larger, or the control unit corrects the target work amount of the compressor immediately after the cut control to be increased as the heat load immediately after the predetermined time passes is larger. For example, the control unit corrects the target work amount of the compressor immediately after the cut control to be increased as an amount of sunlight radiated into the vehicle compartment immediately after the predetermined time passes is larger. Thus, the work amount of the compressor can be suitably controlled.

Further, the control unit corrects the target work amount of the compressor immediately after the cut control to be set at a work amount that is calculated to compensate a shortage of the work amount due to the cut control within a certain constant time. Therefore, the shortage of the work amount of the compressor can be accurately compensated. Further, the control unit can prohibit the cut control while the compressor is controlled based on the target work amount corrected by the control unit.

More preferably, the control unit corrects the target work amount of the compressor immediately after the cut control to be increased up to a maximum work amount of the compressor. In this case, the air condition in the passenger compartment after the cut control can be rapidly changed to suit the passenger's feeling.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic diagram showing a hybrid vehicle on which an air conditioner according to a first embodiment of the present invention is mounted;

FIG. 2 is a schematic diagram showing an entire structure of the air conditioner according to the first embodiment;

FIGS. 3A and 3B are flow diagrams showing air-conditioning control processes of an air-conditioning electronic control unit (ECU) in the air conditioner according to the first embodiment;

FIG. 4 is a graph showing an actual rotation speed of a compressor in the air conditioner and a vehicle speed according to the first embodiment;

FIG. 5 is a flow diagram showing air-conditioning control processes of an air-conditioning ECU in an air conditioner according to a second embodiment of the present invention;

FIG. 6 is a flow diagram showing air-conditioning control processes of an air-conditioning ECU in an air conditioner according to a third embodiment of the present invention;

FIG. 7 is a flow diagram showing air-conditioning control processes of an air-conditioning ECU in an air conditioner according to a fourth embodiment of the present invention;

FIG. 8 is a flow diagram showing air-conditioning control processes of an air-conditioning ECU in an air conditioner according to a fifth embodiment of the present invention;

FIG. 9 is a flow diagram showing air-conditioning control processes of an air-conditioning ECU in an air conditioner according to a sixth embodiment of the present invention;

FIG. 10 is a flow diagram showing air-conditioning control processes of an air-conditioning ECU in an air conditioner according to a seventh embodiment of the present invention;

FIG. 11 is a flow diagram showing air-conditioning control processes of an air-conditioning ECU in an air conditioner according to an eighth embodiment of the present invention; and

FIG. 12 is a flow diagram showing air-conditioning control processes of an air-conditioning ECU in an air conditioner according to a ninth embodiment of the present invention.

### DETAILED DESCRIPTION OF THE PRESENTLY PREFERRED EMBODIMENTS

Preferred embodiments of the present invention will be described hereinafter with reference to the accompanying drawings.

(First Embodiment)

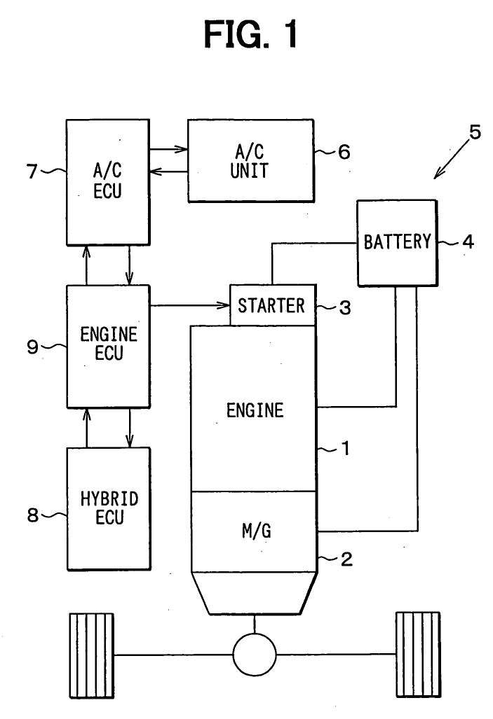

The first embodiment of the present invention will be now described with reference to FIGS. 1-4.

In the first embodiment, an air conditioner for a hybrid vehicle is an automatic air conditioner which automatically controls a temperature in a passenger compartment at a set temperature. Specifically, this automatic air conditioner controls actuators in an air-conditioning unit 6 for air-conditioning the passenger compartment of a hybrid vehicle 5, by using an air-conditioning electronic control unit (ECU) 7.

In addition to the air-conditioning unit 6, various devices, such as a driving engine 1, a motor generator 2, an engine starter 3 and a vehicle battery 4 are also mounted in the hybrid vehicle 5. The driving engine 1 is an engine for driving the hybrid vehicle 5. The motor generator 2 functions as both an electronic motor and an electronic generator. The engine starter 3 includes a starting motor for starting the driving engine 1 and an ignition device. The vehicle battery 4 supplies electric power to the motor generator 2 and the engine starter 3.

The motor generator 2 functions as the electric generator for generating electric power when it is driven by the driving engine 1. Further, the motor generator 2 functions as the electric motor for generating motive power for driving the hybrid vehicle 5 when it is supplied from the vehicle battery 4.

The driving engine 1 can be selectively connected to or disconnected from a shaft of the hybrid vehicle 5. Further, the motor generator 2 can be selectively connected to or disconnected from the shaft of the hybrid vehicle 5. The motor generator 2 is connected to the shaft when the driving engine 1 is not connected to the shaft. Furthermore, the motor generator 2 is automatically controlled (e.g., inverter control) by a hybrid ECU 8. The hybrid ECU 8 controls electric power supply to the motor generator 2 so that the hybrid vehicle 5 is driven by only the motor generator 2 when the hybrid vehicle 5 starts driving or the hybrid vehicle 5 drives at a low speed.

Further, the engine starter 3 is automatically controlled by an engine ECU 9 so that combustion efficiency of gasoline is optimized. The engine ECU 9 controls electric power supply to the engine starter 3 so that the driving engine 1 is driven when a normal driving of the hybrid vehicle 5 or a charging of the vehicle battery 4 is required.

The air-conditioning unit 6 includes an air-conditioning duct 11, a centrifugal blower 12, an evaporator 21. The air-conditioning duct 11 is provided at a front side in the passenger compartment of the hybrid vehicle 5. Further, the air-conditioning duct 11 defines an air passage through which conditioned air (cool air) is introduced into the passenger compartment of the hybrid vehicle 5. The centrifugal blower 12 is disposed in the air-conditioning duct 11 and generates an air flow toward the passenger compartment. The evaporator 21 cools air flowing in the air-conditioning duct 11 so that the passenger compartment is cooled.

Further, an inside air suction port (not shown), an outside air suction port (not shown) and an inside/outside air switching door (not shown) are provided at the most upstream air side of the air-conditioning duct 11. The inside air suction port introduces air (inside air) inside the passenger compartment. The outside air suction port introduces air (outside air) outside the passenger compartment. The inside/outside air switching door switches an air suction mode. At the most downstream air side of the air-conditioning duct 11, a defroster opening portion (not shown), a face opening portion (not shown), a foot opening portion (not shown) and a mode switching door (not shown) for switching an air outlet mode are provided.

The centrifugal blower 12 includes a centrifugal fan 13 which is rotatably disposed in a scroll case integrated with the air-conditioning duct 11, and a blower motor 14 for driving the centrifugal fan 13. Then, the blower motor 14 controls an air blowing amount (rotation speed of the centrifugal fan 14) in accordance with a blower voltage applied to the blower motor 14 through a blower driving circuit 15.

The evaporator 21 is a component of a refrigerant cycle system 20 and is disposed so as to entirely cross the air passage in the air-conditioning duct 11. The refrigerant cycle system 20 includes a compressor 23, a condenser 24, a receiver 25, an expansion valve 26, the above evaporator 21 and refrigerant piping for connecting these components. The compressor 23 compresses gas refrigerant, which is sucked from the evaporator 21, by rotation of the electric motor 22. The condenser 24 is an exterior heat exchanger for condensing and liquefying the gas refrigerant discharged from the compressor 23. The receiver 25 separates the refrigerant condensed and liquefied by the condenser 24 into gas refrigerant and liquid refrigerant, so that only the liquid refrigerant flows to a downstream refrigerant side. The expansion valve 26 decompresses and expands the liquid refrigerant from the receiver 25. The evaporator 21 vaporizes the gas-liquid two-phase refrigerant decompressed and expanded in the expansion valve 26.

Furthermore, in the refrigerant cycle system 20 according to the first embodiment, a cooling fan 27 and an electric motor 28 are provided. The cooling fan 27 blows outside air (cooling air) toward the condenser 24 forcibly. The electric motor 28 drives the cooling fan 27 to rotate.

In the refrigerant cycle system 20 according to the first embodiment, motive power of the electric motor 22 is transmitted to the compressor 23 so that air cooling operation is performed by the evaporator 21, when electric power is supplied to the electric motor 22. When electric power is not supplied to the electric motor 22, the electric motor 22 is stopped so that the air cooling operation by the evaporator 21 is stopped.

Then, electric power supplied from the vehicle battery 4 to the electric motor 22 is controlled continuously or stepwisely by an air-conditioning inverter 29. Therefore, a rotation speed of the electric motor 22 is variably controlled. Further, the rotation speed of the electric motor 22 is changed, so that an amount of refrigerant discharged by the compressor 23 is changed. As a result, an amount of refrigerant circulated in the refrigerant cycle system 20 is adjusted. Accordingly, cooling capacity of the evaporator 21, that is, cooling capacity of the refrigerant cycle system 20 is controlled. In other words, a work amount of the compressor 23 is controlled.

Next, a structure of a control system in the air-conditioning unit 6 according to the first embodiment will be explained. Communication signals outputted from the engine ECU 9, switch signals from switches on a control panel (not shown) provided at a front side in the passenger compartment and sensor signals from sensors are inputted to the air-conditioning ECU 7. Here, the above communication signals outputted from the engine ECU 9 include a cut request signal in a vehicle acceleration, for requesting a cut control in the vehicle acceleration which will be described below.

The switches on the control panel include a temperature setting lever, an air-conditioning switch, an air amount changing over switch, a suction-port changing over switch, a defroster switch and the like. The temperature setting lever sets a temperature in the passenger compartment to a requested temperature. The air-conditioning switch directs starting and stopping operation of the refrigerant cycle system 20 (compressor 23). The air amount changing over switch sets an amount of air blown by the centrifugal fan 13. The suction-port changing over switch selects an air suction mode. The defroster switch sets a defroster mode as an air outlet mode.

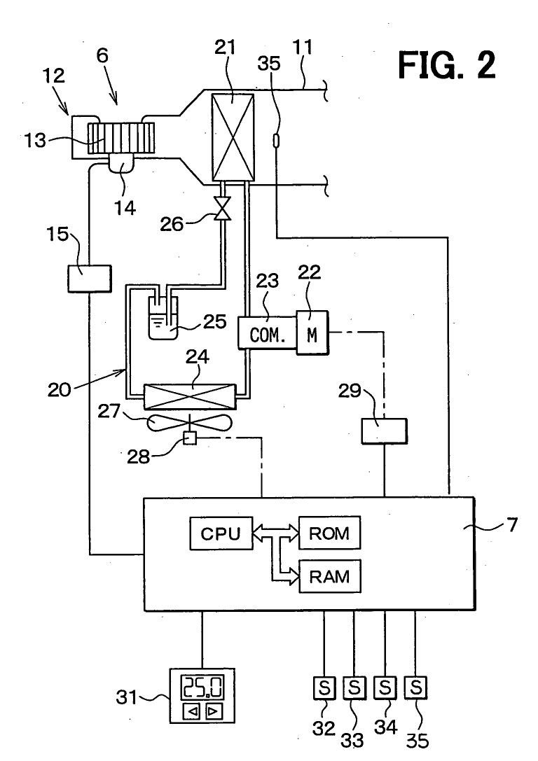

As shown in FIG. 2, the above sensors include an inside air temperature sensor 32, an outside air temperature sensor 33, a solar radiation sensor 34, an evaporator air temperature sensor 35 and the like. The inside air temperature sensor 32 detects an air temperature in the passenger compartment. The outside air temperature sensor 33 detects an air temperature outside the passenger compartment. The solar radiation sensor 34 detects an amount of sunlight radiated into the passenger compartment. The evaporator air temperature sensor 35 detects an air-cooling degree in the evaporator 21.

Among the above sensors, thermistors are used as the inside air temperature sensor 32, the outside air temperature sensor 33 and the evaporator air temperature sensor 35. Further, photodiodes are used as the solar radiation sensor 34. Specifically, the evaporator air temperature sensor 35 detects a temperature TE of air immediately after flowing through the evaporator 21 so as to detect the air-cooling degree.

Furthermore, a battery capacity detection sensor 36 and the like are provided in order to detect a driving condition of the hybrid vehicle 5. The battery capacity detection sensor 36 detects a capacity (residual charging degree) of the vehicle battery 4. For example, a charge/discharge measuring instrument (e.g., battery charge counter) can be used in order to measure the capacity of the vehicle battery 4. A charge/discharge amount of the vehicle battery 4 is measured by using the charge/discharge measuring instrument, so that the capacity of the vehicle battery 4 is detected.

The capacity of the vehicle battery 4 can be calculated based on magnitude of a discharge current, a discharge time, a temperature of an electrolytic solution or a specific gravity of the electrolytic solution. The capacity of the vehicle battery 4 can be also calculated by combining the above physical quantities. In the first embodiment, when the capacity of the vehicle battery 4 becomes equal to or lower than 80%, an electric signal (cut request signal in the acceleration) for stopping operation of the electric motor 22 in the compressor 23, is outputted to the air-conditioning ECU 7. Thus, the electric motor 22 in the compressor 23 is stopped, so that the cut control in acceleration is performed.

Here, the cut control in acceleration is a control where the work amount of the compressor 23 is forcibly reduced when a running load of the vehicle exceeds a predetermined load. When the vehicle is accelerated, for example, in order to pass other vehicle which runs forward, an auxiliary motor driven by the vehicle battery 4 is used for driving the hybrid vehicle 5 in addition to the driving engine 1. That is, an auxiliary driving is performed. In the auxiliary driving, the cut control in acceleration is performed in order to ensure the acceleration by reducing a load of the vehicle battery 4.

Specifically, the cut control in acceleration is performed when the running load of the driving engine 1 or the load of the vehicle battery 4 exceeds a predetermined load (heavy load), for example, by a pedaling of an acceleration pedal. In addition to the vehicle acceleration where the vehicle is actually accelerated, going up in a slope is also an example of the heavy load.

In order to detect the driving condition of the hybrid vehicle 5, an engine rotation speed sensor (not shown) or a vehicle speed sensor (not shown), which is connected to the engine ECU 9, can be also used. In this case, the air-conditioning ECU 7 can receive a signal representing an engine rotation speed or a vehicle speed from the above sensors through a communication line.

Inside the air-conditioning ECU 7, a microcomputer, which includes devices such as a central processing unit (CPU), a read only memory (ROM) and a random access memory (RAM), is provided. Sensor signals from the sensors 32-36 are converted from an analog signal to a digital signal in an input circuit (not shown) of the air-conditioning ECU 7. Then, the converted sensor signals are inputted to the microcomputer. When a key switch of the hybrid vehicle 5 is set to an ignition position, direct-current (DC) voltage is supplied from the vehicle battery 4. Then, operation of the air-conditioning ECU 7 is started.

Next, operation of the air conditioner according to the first embodiment will be explained.

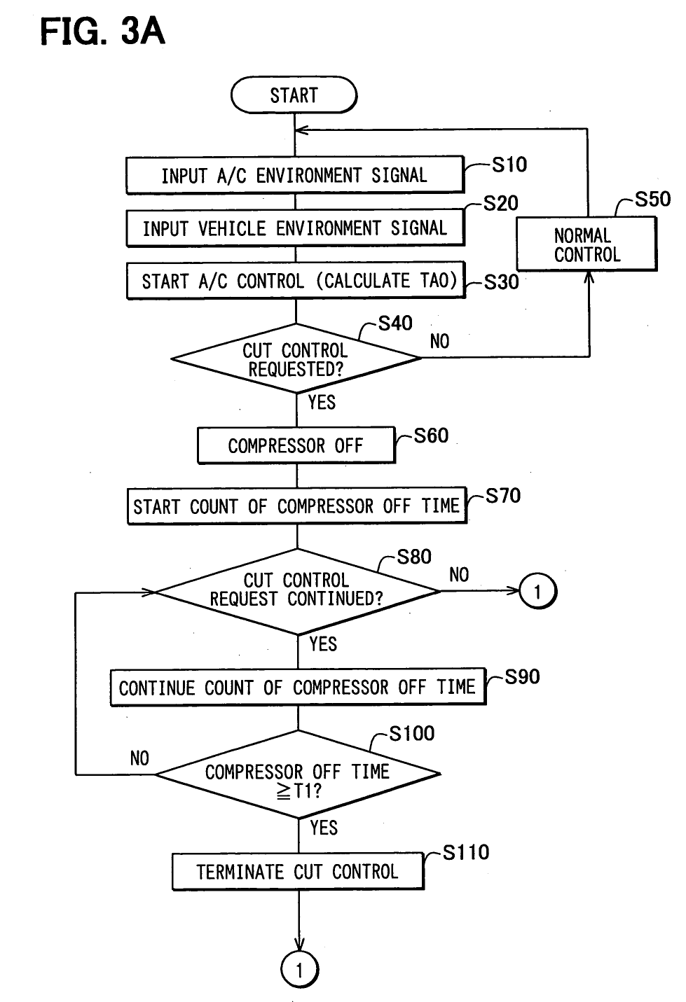

When the key switch of the hybrid vehicle 5 is set to the ignition position, the DC voltage is supplied from the vehicle battery 4 to the air-conditioning ECU 7. Then, a routine in FIG. 3A is started and initializing is performed. At step S10, air-conditioning environment signals such as sensor signals and switch signals are inputted. The sensor signals are inputted from the sensors 32-35, and the switch signals are inputted from the switches, such as the temperature setting lever and the air amount changing over switch. At step S20, a vehicle speed signal from the vehicle speed sensor and the like are inputted as a signal regarding vehicle environment.

At step S30, a target temperature TAO of air to be blown into the passenger compartment is calculated based on a set temperature set by the temperature setting lever, an inside air temperature, an outside air temperature, a sunlight amount and the like. The target temperature TAO is a blown air temperature which is required for maintaining the inside air temperature at the set temperature. At step S30, the air outlet mode, a target air blowing amount, a target evaporator air temperature TEO and the like are determined based on the calculated target temperature TAO.

Next, in order to control an actual evaporator air temperature TE to the target evaporator air temperature TEO, a rotation speed of the compressor 23 is calculated as a target work amount. That is, the target rotation speed as the target work amount of the compressor 23 is calculated based on a heat load.

At step S40, it is determined whether the cut request signal in acceleration is inputted from the engine ECU 9 to the air-conditioning ECU 7. When the cut request signal is not inputted, the processing proceeds to step S50. At step S50, the compressor 23 is operated so that the rotation speed of the compressor 23 is maintained at the calculated target rotation speed, and a normal control is performed. Specifically, in the normal control of the compressor 23, the rotation speed of the electric motor 22 is controlled by controlling operation of the air-conditioning inverter 29 based on the calculated rotation speed in accordance with the heat load. Further, operations of the various actuators and the blower motor 14 are controlled so that the determined air outlet mode and the target air blowing amount are obtained.

To the contrary, when the cut request signal from the engine ECU 9 is inputted, the processing proceeds to step S60. At step S60, operation of the compressor 23 is stopped. Thus, this control, where the compressor 23 is stopped according to the cut request signal from the engine ECU 9, is called as the cut control in acceleration, in the first embodiment. The cut control is terminated after a predetermined time T1 passes.

Specifically, a counting of an operation stop time of the compressor 23 starts at step S70. At step S80, it is determined whether the input of the cut request signal from the engine ECU 9 continues. When the input of the cut request signal continues, counting the stop time of the compressor 23 is continued at step S90. Then, at step S100, it is determined whether the counted time reaches the predetermined time T1. When the counted time does not reach the predetermined time T1, the processing returns to step S80. When the counted time reaches the predetermined time T1, the cut control is terminated at step S110.

When the cut control is terminated or it is determined that the cut request signal is not inputted at step S80, the counting of the stop time of the compressor 23 is terminated at step S120 in FIG. 3B. Then, at step S130-160, the rotation speed of the compressor 23, which is calculated based on the heat load at step S30, is corrected to be increased.

Specifically, a correction amount (increment of the rotation speed) is calculated at step S130. Then, at step S140, it is determined whether the rotation speed, which is increased by the calculated correction amount, is equal to or larger than the maximum rotation speed of the electric motor 22. When the increased rotation speed is equal to or larger than the maximum rotation speed, the maximum rotation speed is set as the target rotation speed immediately after the cut control at step S150. To the contrary, when the increased rotation speed is less than the maximum rotation speed, the increased rotation speed is set as the target rotation speed. Then, at step S160, the rotation speed of the electric motor 22 is controlled by the operation of the air-conditioning inverter 29 so that the rotation speed of the compressor 23 approximates to the above corrected target rotation speed.

The above correction amount is calculated based on the graph shown at step S130 in FIG. 3B. Specifically, the calculated increment (correction amount) of the rotation speed is increased as the stop time of the compressor 23 is longer. However, a predetermined correction amount is the upper limit (e.g., 1000 rpm) when the stop time of the compressor 23 is longer than a predetermined threshold time (e.g., 5 seconds).

As described above, in the normal control, the compressor 23 is operated so that the rotation speed is maintained at the target rotation speed calculated based on the heat load at step S30. To the contrary, when the cut control in acceleration is performed, the compressor 23 is forcibly stopped. In the first embodiment, the target rotation speed immediately after the predetermined time T1 passes is corrected to be increased more than a rotation speed calculated based on the heat load, when the control is changed from the cut control to the normal control. The cut control is continued for the predetermined time T1 and then the control is changed to the normal control again. Therefore, the air condition in the passenger compartment can be made to suit a passenger's feeling immediately after the cut control in acceleration is terminated.

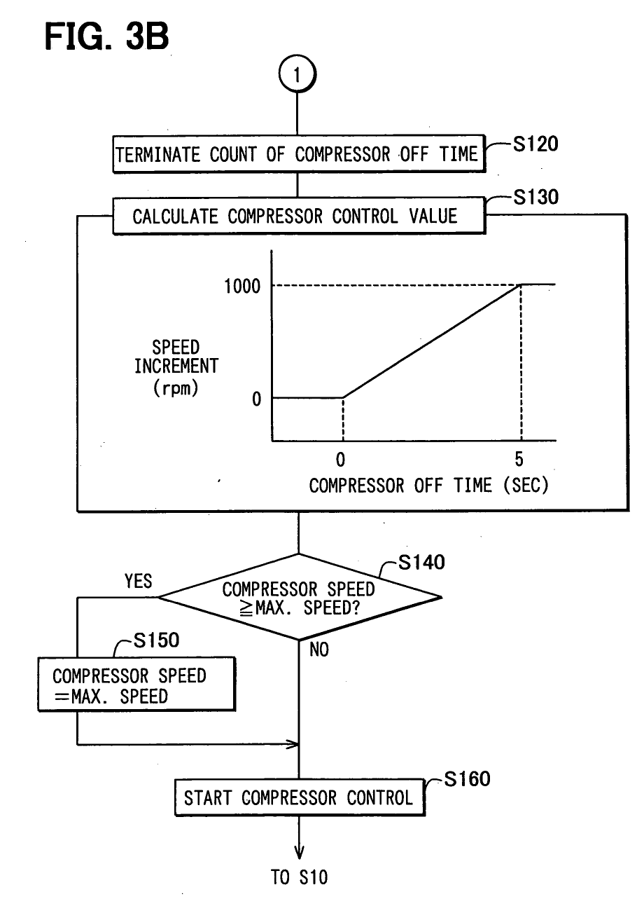

Here, advantages of the air conditioner according to the first embodiment will be now described. In FIG. 4, the air-conditioning, that is, the rotation speed of the compressor 23 is normally controlled (normal control) when the vehicle stops (vehicle speed is 0). Specifically, the rotation speed of the compressor 23 is controlled so as to correspond to the target rotation speed calculated based on the heat load. Then, the operation of the compressor 23 is forcibly stopped (the rotation speed is 0 rpm) because the general control is changed to the cut control. The compressor 23 is stopped until a predetermined time T1 passes after the vehicle starts. Then, immediately after the predetermined time T1 passes, the compressor 23 is controlled so that the rotation speed approximates to the corrected target rotation speed which is corrected so that the target rotation speed calculated based on the heat load is increased.

When the above correction is not performed and the rotation speed of the compressor 23 is controlled in accordance with the target rotation speed calculated based on the heat load, an actual rotation speed of the compressor 23 is not increased greatly as shown by a dot line in FIG. 4. In this case, it takes a time T2 to compensate a shortage of cooling capacity. However, when the correction of the target rotation speed of the compressor 23 according to the first embodiment is performed, the actual rotation speed of the compressor 23 is increased greatly as shown by a solid line in FIG. 4. Therefore, a time T3, for compensating the shortage of cooling capacity because of the cut control, can be made shorter than the time T2. Accordingly, the air condition in the passenger compartment can be made to suit the passenger's feeling immediately after the cut control of the compressor 23 is finished.

(Second Embodiment)

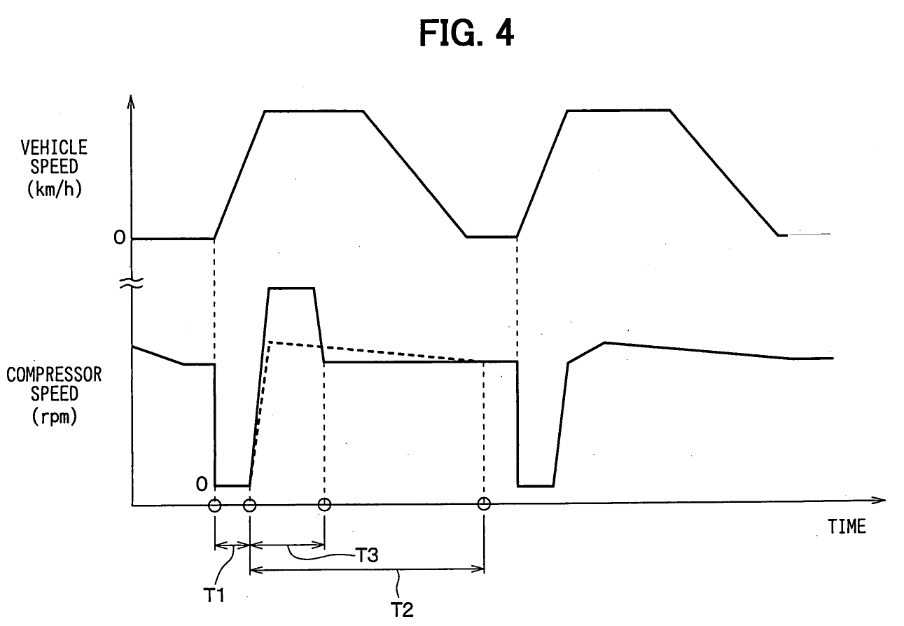

The second embodiment of the present invention will be now described with reference to FIG. 5.

In the above-described first embodiment, the electric compressor, which changes the work amount by changing the rotation speed, is used as the compressor 23. Further, the target rotation speed is corrected to be increased immediately after the cut control is terminated. To the contrary, in the second embodiment, a well-known variable displacement compressor is used as the compressor 23. The variable displacement compressor changes the work amount by changing a discharge amount per rotation. A target discharge amount is corrected to be increased more than a calculated discharge amount that is calculated based on the heat load, immediately after the cut control is terminated.

In the second embodiment, steps S130, S140 and S150 in FIG. 3B of the first embodiment are modified to steps S131, S141 and S151 in FIG. 5, respectively. As described in the first embodiment, in the normal control, the compressor 23 is operated so that the discharge amount is maintained at the target discharge amount calculated based on the heat load at step S30. To the contrary, in the cut control, the compressor 23 is forcibly stopped. The cut control is continued for the predetermined time T1 and the cut control is changed to the normal control again. In this case, in the second embodiment, the target discharge amount immediately after the predetermined time T1 passes is corrected to be increased.

Specifically, at step S131, the compressor control value is calculated based on the compressor stop time in the cut control. That is, increment percentage of the discharge amount of the compressor 23 is calculated. Then, the discharge amount of the compressor 23 calculated based on the heat load is corrected to be increased by the increment percentage calculated at step S131. Next, at step S141, the corrected discharge amount is compared with the maximum discharge amount. When the corrected discharge amount is larger that the maximum discharge amount, the discharge amount of the compressor 23 is set at the maximum discharge amount, and the compressor control is started at step S160. When the corrected discharge amount is smaller than the maximum discharge amount, the compressor control at step S160 is preformed by using the corrected discharge amount. In the second embodiment, the other control parts are similar to those of the above-described first embodiment. Therefore, the same effect as that of the first embodiment can be obtained.

(Third Embodiment)

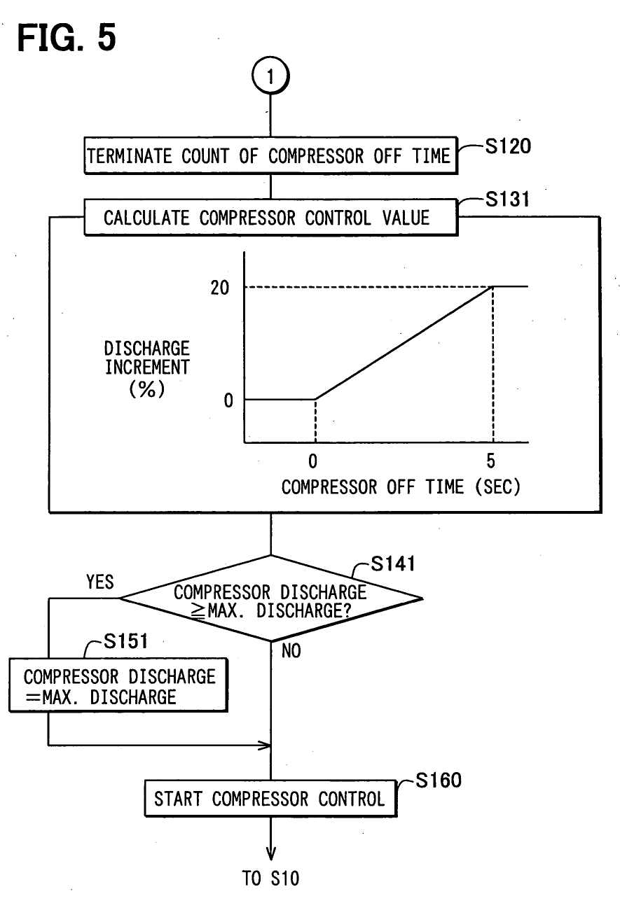

The third embodiment of the present invention will be now described with reference to FIG. 6.

In the above-described first embodiment, the electric compressor, in which the work amount is changed by changing the rotation speed, is used as the compressor 23. Further, the target rotation speed is corrected to be increased immediately after the cut control is terminated. To the contrary, in the third embodiment, a fixed displacement compressor, which includes an electromagnetic clutch, is used as the compressor 23. ON/OFF of the electromagnetic clutch is controlled so that the actual evaporator air temperature TE approximates to the target evaporator air temperature TEO. Then, in the cooling operation, the target evaporator air temperature TEO is corrected to be decreased immediately after the cut control is terminated.

In the third embodiment, steps S130, S140 and S150 in the first embodiment are modified to steps S132, S142 and S152 in FIG. 6 respectively. As described above, in the normal control, the compressor 23 is operated so that the actual evaporator air temperature TE is maintained at the target evaporator air temperature TEO calculated based on the heat load at step S30. To the contrary, in the cut control, the compressor 23 is forcibly stopped. In the third embodiment, the target evaporator air temperature TEO immediately after the predetermined time T1 passes is corrected to be reduced when the normal control is changed to the cut control, the cut control is continued for the predetermined time T1 after the normal control is changed to the cut control, and when the cut control is changed to the normal control again.

Specifically, at step S132, the compressor control value is calculated based on the compressor stop time in the cut control. That is, a decrement value of the target evaporator air temperature TEO is calculated. Then, the target evaporator air temperature TEO calculated based on the heat load is corrected to be reduced by the decrement value of the target evaporator air temperature TEO calculated at step S132. Next, at step S142, the corrected target evaporator air temperature TEO is compared with the lowest evaporator air temperature. When the corrected target evaporator air temperature TEO is lower than the lowest evaporator air temperature, the target evaporator air temperature TEO is set at the lowest evaporator air temperature, and the compressor control is started at step S160. When the corrected target evaporator air temperature TEO is higher than the lowest evaporator air temperature, the compressor control at step S160 is preformed by using the corrected target evaporator air temperature TEO. In the third embodiment, the other control parts are similar to those of the above-described first embodiment. Therefore, the same effect as that of the first embodiment can be obtained.

(Fourth Embodiment)

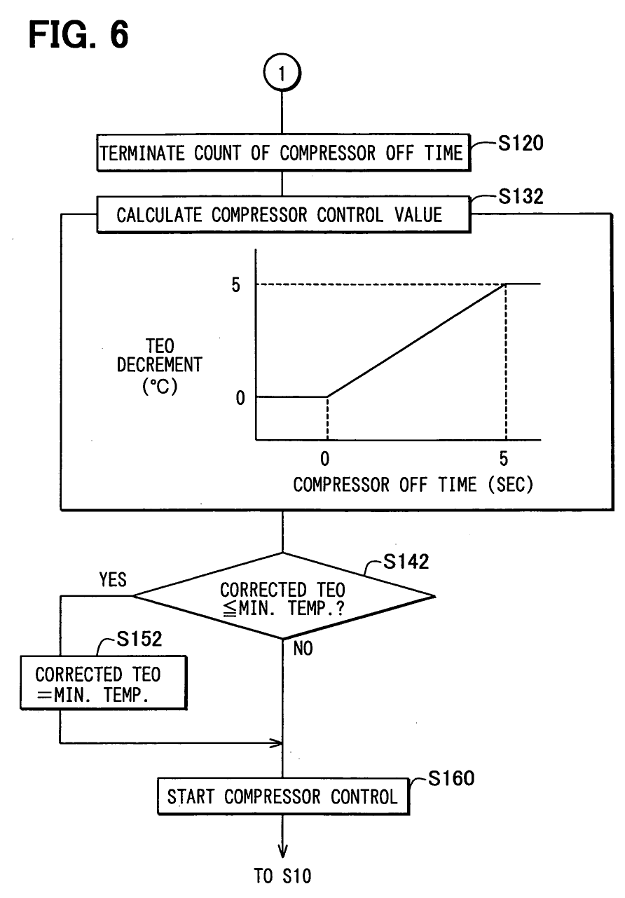

The fourth embodiment of the present invention will be now described with reference to FIG. 7.

In the above-described first embodiment, the engine ECU 9 determines whether or not the cut control in acceleration needs to be performed. Further, the engine ECU 9 outputs the cut request signal to the air-conditioning ECU 7. To the contrary, in the fourth embodiment, the air-conditioning ECU 7 determines whether the cut control needs to be performed. Accordingly, in the fourth embodiment, steps S40 and S80 in the first embodiment are modified to steps S41 and S81 in FIG. 7 respectively. Specifically at step S41, the air-conditioning ECU 7 determines whether or not the cut control needs to be performed based on the vehicle signals from the engine ECU 9. Further, at step S81, the air-conditioning ECU 7 determines whether the cut control needs to be continued.

In the fourth embodiment, it is unnecessary to transmit the cut request signal from the engine ECU 9 to the air-conditioning ECU 7. That is, the air-conditioning ECU 7 directly determines whether or not the cut control is necessary based on the vehicle signal from the engine ECU 9. Therefore, a time, between a determination of the cut control and a start of the cut control, can be shortened. Accordingly, responsibility of the cut control can be improved. In the fourth embodiment, the other control steps are similar to those of the above-described first embodiment.

(Fifth Embodiment)

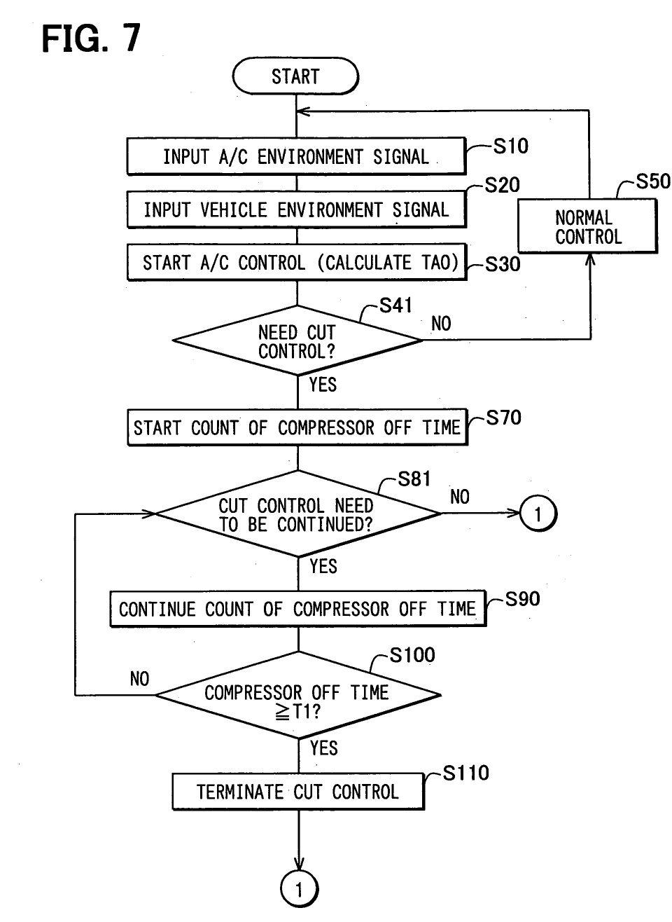

The fifth embodiment of the present invention will be now described with reference to FIG. 8.

In the above-described first to fourth embodiments, the cut control, where the work amount of the compressor 23 is forcibly reduced to be smaller than the target work amount of the compressor 23, is performed when the running load of the vehicle exceeds the predetermined load.

In contrast, in the fifth embodiment, the cut control can be used in a case where the air-conditioning switch is turned off temporarily and is turned on again because of mistake switch operation of a passenger. In this case, the work amount of the compressor 23 becomes smaller than the target work amount substantially.

Specifically, steps S40, S80 and S110 in FIG. 3A of the first embodiment are modified to steps S42, S82 and S111 in FIG. 8. When it is determined that the air-conditioning switch is turned on at step S42, the normal control at step S50 is performed. As described above, in the normal control, the compressor 23 is operated so that the rotation speed of the compressor 23 is maintained at the target rotation speed calculated based on the heat load at step S30. Further, when it is determined that the stop state of the air-conditioning switch is continued at step S82, steps S90 and S100 are performed similarly to those in the first embodiment. When it is determined that the stop state of the air-conditioning switch is not continued at step S82, the processes in FIG. 3B is performed. That is, the target rotation speed of the compressor 23 is corrected to be increased, so that the cooling capacity can be immediately increased. When it is determined that the compressor 23 is turned off over the predetermined time T1 at step S100, the normal control after the compressor 23 is turned off is performed at step S111.

In the fifth embodiment, when a control state is changed from the normal control to the above-described temporary OFF state of the air conditioner because of mistake switch operation of a passenger and is returned to the normal control, the target rotation speed of the compressor 23 immediately after the control state is returned to the normal control is corrected to be increased more than a target rotation speed calculated based on the heat load. Therefore, the same advantages as that of the first embodiment can be obtained.

(Sixth Embodiment)

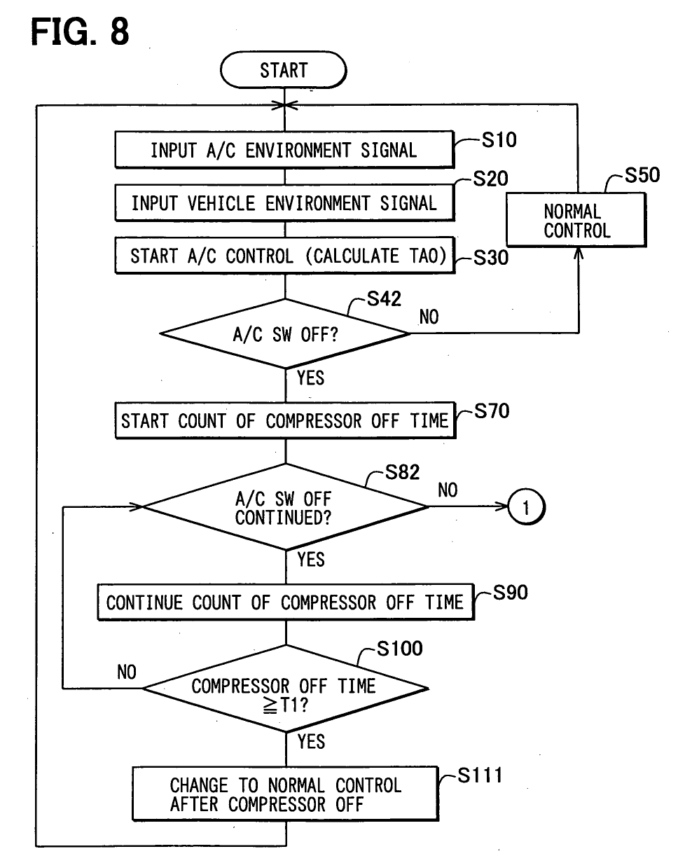

The sixth embodiment of the present invention will be now described with reference to FIG. 9.

In the above-described first embodiment, the calculated increment (correction amount) of the rotation speed of the compressor 23 is increased as the stop time of the compressor 23 is longer. To the contrary, in the sixth Embodiment, step S130 in FIG. 3B is modified to step S133 in FIG. 9. At step S133, it is determined whether the rotation speed needs to be increased, depending on whether the stop time is longer than a predetermined time (e.g., 1 second). Only when the stop time of the compressor 23 is longer than the predetermined time, the correction amount is set to the maximum rotation speed (e.g., 15000 rpm) of the compressor 23 regardless of the stop time. In contrast, when the stop time of the compressor 23 is shorter than the predetermined time, the correction amount is set at zero.

(Seventh Embodiment)

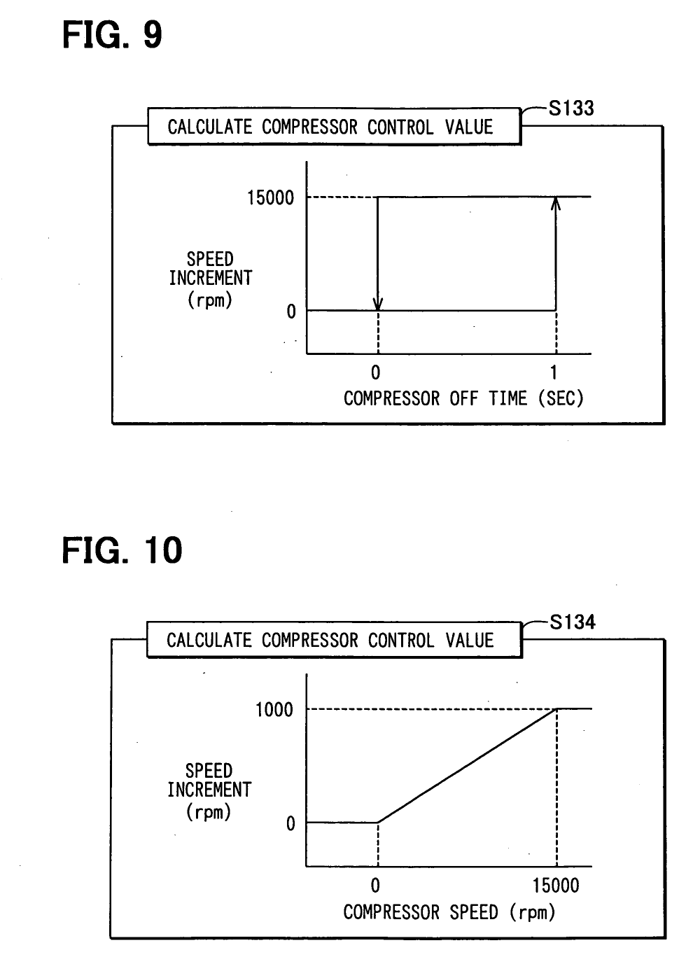

The seventh embodiment of the present invention will be now described with reference to FIG. 10.

In the seventh embodiment, step S130 in FIG. 3B is modified to step S134 in FIG. 10. At step S134, the calculated increment (correction amount) of the rotation speed of the compressor 23 is increased, as the rotation speed of the compressor 23 immediately before the cut control is started is larger. It is possible that the above calculated increment (correction amount) of the rotation speed is increased as the heat load immediately after the predetermined time T1 passes is larger. For example, the calculated increment of the rotation speed is increased as an amount of sunlight radiated into the passenger compartment immediately after the predetermined time T1 passes is larger.

(Eighth Embodiment)

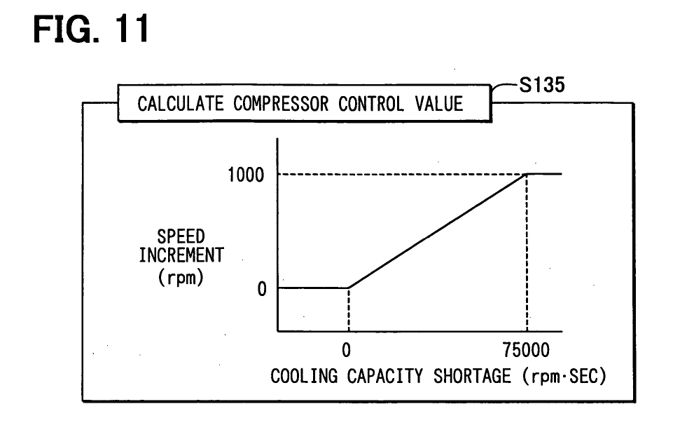

The eighth embodiment of the present invention will be now described with reference to FIG. 11.

In the eighth embodiment, step S130 in FIG. 3B is modified to step S135 in FIG. 11. At step S135, the calculated increment (correction amount) of the rotation speed is increased as the rotation speed of the compressor 23 immediately before the cut control is started is larger and the stop time T1 of the compressor 23 is longer. That is, a shortage of the cooling capacity due to the cut control is assumed to be a product of the stop time T1 and the rotation speed of the compressor 23 immediately before the cut control is started. The calculated increment (correction amount) of the rotation speed is increased as the assumed shortage of cooling capacity becomes large.

(Ninth Embodiment)

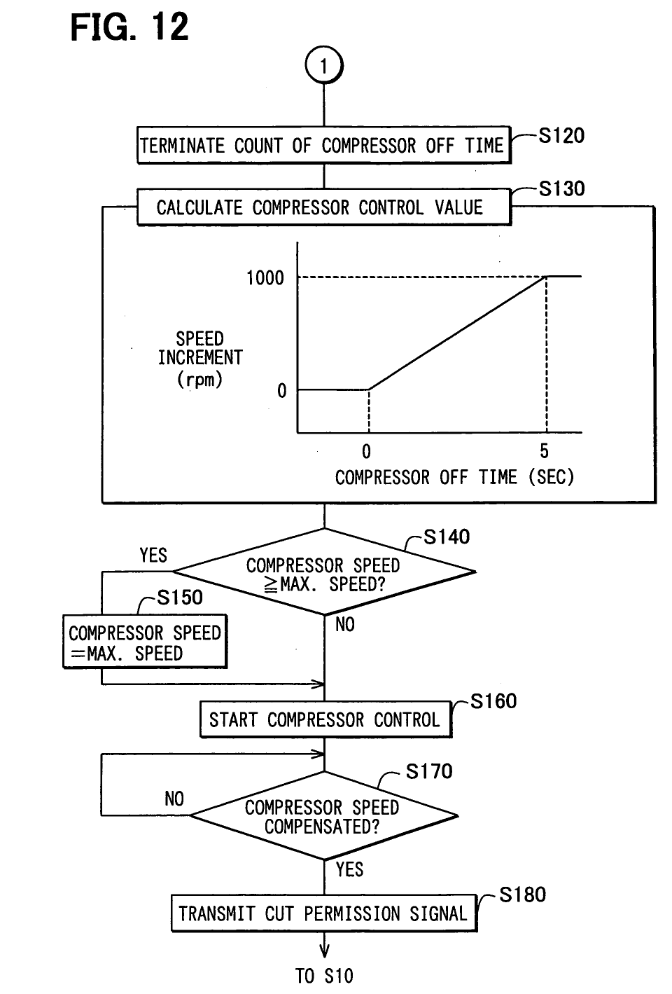

The ninth embodiment of the present invention will be now described with reference to FIG. 12.

In the ninth embodiment, the cut control is prohibited for a time T3 while the shortage of the cooling capacity due to the cut control is compensated. Specifically, as shown in FIG. 12, steps S170 and S180 are added after step S160 in FIG. 3B of the first embodiment. At step S160, the operation of the air-conditioning inverter 29 is controlled so that the rotation speed of the compressor 23 approximates to the above target rotation speed. Then, at step S170, it is determined whether the shortage of the cooling capacity due to the cut control is compensated by correction and it is determined whether the correction is finished.

When it is determined that the correction for compensating the shortage of the cooling capacity is completed, a permission signal for permitting the cut control is transmitted to the engine ECU 9. The engine ECU 9 is prohibited to output the cut request signal in acceleration to the air-conditioning ECU 7 unless the permission signal is outputted to the engine ECU 9.

(Tenth Embodiment)

In the above-described first embodiment, at step S130, the increment (correction amount) of the rotation speed is increased as the stop time of the compressor 23 in the cut control is longer. To the contrary, in the tenth Embodiment, the work amount to be increased by the correction is set to a work amount that is enough to compensate a shortage of the work amount due to the above cut control within a certain constant time.

Specifically, a shortage Q (rpm·sec) of the cooling capacity and an incremental rotation speed Δf (rpm) are calculated based on the following formulas (1) and (2) respectively.

Q=f×T1 (1)

Δf=Q÷T0 (2)

wherein, “f” is the rotation speed (rpm) of the compressor 23 immediately before the cut control is started, T1 is the cut control time (sec), and T0 is the constant time (sec).

Here, the engine ECU 9 is prohibited to output the cut request signal successively unless a predetermined compensation time passes. Thus, hunting of the air conditioner can be prevented.

Considering the above control for preventing the hunting in the engine ECU 9, the constant time T0 in the formula (2) is set to be within the above predetermined compensation time. Thus, a shortage of the work amount in a first cut control can be compensated before a second cut request signal is outputted after the first cut control is terminated.

(Other Embodiments)

Although the present invention has been fully described in connection with the preferred embodiments thereof with reference to the accompanying drawings, it is to be noted that various changes and modifications will become apparent to those skilled in the art.

For example, in the above-described first to tenth embodiments, the target work amount is corrected to be increased immediately after the cut control is terminated in the cooling operation. However, the present invention can be applied in a heating operation, where heat is radiated in the interior heat exchanger (evaporator) 21 by using the compressor 23 used for a heat pump cycle. In this case, the target work amount is also corrected to be increased immediately after the cut control is terminated.

Further, in the above-described first to tenth embodiments, the correction control, where the target work amount is increased immediately after the cut control is terminated, is performed at steps S130-S160 that are different from the control of step S30. However, this correction control can be performed at step S30, where the target temperature TAO for the normal control is calculated.

Specifically, the formula for calculating the target temperature TAO at step S30 can be changed immediately after the cut control is terminated. For example, coefficients multiplied by variables such as the set temperature, the inside air temperature, the outside air temperature and the amount of sunlight are modified. Otherwise, a graph showing a relationship between the above quantities and the target temperature TAO can be changed.

Further, in the cut control according to the above embodiments except for the fifth embodiment, the compressor 23 is stopped. However, in the cut control according to the present invention, it is possible the compressor 23 is not stopped but the work amount of the compressor 23 is forcibly reduced smaller than the target work amount in the normal operation.

Such changes and modifications are to be understood as being within the scope of the present invention as defined by the appended claims.

What is claimed is:

1. An air conditioner for a vehicle, comprising:
a compressor for compressing and discharging refrigerant in a refrigerant cycle;
an interior heat exchanger that performs a heat exchange between the refrigerant circulated by operation of the compressor and air to be blown into a vehicle compartment; and
a control unit for controlling a work amount of the compressor, wherein:
the control unit has a target work amount calculating means for calculating a target work amount of the compressor per a regular time based on a heat load of the interior heat exchanger;
the compressor is controlled by the control unit to perform a normal control where the compressor is operated based on the target work amount, and a cut control where the work amount of the compressor is forcibly reduced smaller than the target work amount; and
the control unit corrects the target work amount calculated by the target work amount calculating means based on the heat load to be increased immediately after the cut control, when the normal control is performed after the cut control is performed for a predetermined time.

2. The air conditioner according to claim 1, wherein the control unit controls the work amount of the compressor to be forcibly reduced in the cut control, when a running load of the vehicle exceeds a predetermined load.

3. The air conditioner according to claim 1, wherein the control unit corrects the target work amount of the compressor immediately after the cut control to be increased as the predetermined time is longer.

4. The air conditioner according to claim 1, wherein the control unit corrects the target work amount of the compressor immediately after the cut control to be increased as the work amount of the compressor immediately before the cut control is larger.

5. The air conditioner according to claim 1, wherein the control unit corrects the target work amount of the compressor immediately after the cut control to be increased as the heat load immediately after the predetermined time passes is larger.

6. The air conditioner according to claim 5, wherein the control unit corrects the target work amount of the compressor immediately after the cut control to be increased as an amount of sunlight radiated into the vehicle compartment immediately after the predetermined time passes is larger.

7. The air conditioner according to claim 1, wherein the control unit corrects the target work amount of the compressor immediately after the cut control to be increased up to a maximum work amount of the compressor.

8. The air conditioner according to claim 1, wherein the control unit corrects the target work amount of the compressor immediately after the cut control to be set at a work amount that is calculated to compensate a shortage of the work amount due to the cut control within a certain constant time.

9. The air conditioner according to claim 1, wherein the control unit prohibits the cut control while the compressor is controlled based on the target work amount corrected by the control unit.

10. The air conditioner according to claim 1, wherein:
the compressor includes an electric compressor and at least an electric motor for driving the electric compressor;
the control unit changes the work amount by changing a rotation speed of the electric motor;
the target work amount calculating means calculates the rotation speed as the target work amount per the regular time; and
the control unit corrects the rotation speed immediately after the cut control to be increased.

11. The air conditioner according to claim 10, wherein:
the compressor is disposed to be rotated by a vehicle driving engine in addition to the electric motor.

12. The air conditioner according to claim 1, wherein:
the compressor is a variable displacement compressor which changes the work amount by changing a discharge amount per rotation;
the target work amount calculating means calculates the discharge amount as the target work amount per the regular time; and
the control unit corrects the discharge amount immediately after the cut control to be increased.

13. The air conditioner according to claim 1, wherein:
the target work amount calculating means calculates a target temperature of the interior heat exchanger as the target work amount per the regular time;
the compressor is disposed to be driven by a driving engine through an interrupting member so that an actual temperature of the interior heat exchanger approximates to the target temperature; and
the control unit performs at least one of a correction for reducing the target temperature immediately after the cut control in a cooling operation where the interior heat exchanger cools air, and a correction for increasing the target temperature immediately after the cut control in a heating operation where the interior heat exchanger heats air.

14. The air conditioner according to claim 13, wherein:
the compressor is disposed to be driven by an electric motor in addition to the driving engine.
